(19) United States
(12) Patent Application Publication
(10) Pub. No.: US 2008/0052620 A1
(43) Pub. Date: Feb. 28, 2008

(54) Method and server system for enabling a customer to create a customized publication through the internet

(76) Inventor: Wei-Ru Hwang, Kaohsiung City (TW)

Correspondence Address: Paul D. Greeley;Ohlandt, Greeley, Ruggiero & Perle, L.L.P., 10 Floor, One Landmark Square, Stamford, CT, 06901-2682, US

(21) Appl. No.: 11/509,993

(22) Filed: Aug. 25, 2006

(51) Int. Cl. G06F 17/00

(52) U.S. Cl. 715/272; 715/256; 715/243

(57) ABSTRACT

In a method for enabling a customer to create a customized publication through the Internet, a template database having a plurality of publication template files is established in a server system. Each publication template file has text block objects and image objects. In response to a connection made by the customer to the server system via a network-accessing device, the server system allows the customer to select one of the publication template files from the template database. The server system is also enabled to provide a text editing function and an image editing function to allow the customer to edit the text block objects and the image objects in the selected publication template file, thereby generating a customized publication electronic file for the customer, which is then stored in a customized publication database of the server system.

### BACKGROUND OF THE INVENTION

1. Field of the Invention

The invention relates to a method and server system for creating a customized publication, more particularly to a method and server system for enabling a customer to create a customized publication through the Internet.

2. Description of the Related Art

Due to thriving developments of electronic commerce-related techniques, consumers can now use network-accessing devices, such as personal computers, at home to connect to a web site set up by a store through the Internet, and can make direct payments online in a specific manner (e.g., payment by credit cards) so as to obtain paid online services offered by the store or to subsequently receive physical merchandise from the store.

For example, there exist on the Internet web sites that can help customers make customized greeting cards. Such web sites provide several card templates. Each card template contains interesting characters or animal images. A customer can insert an image block of his/her own face into the image so as to produce a very interesting picture of himself/herself. The customer can then purchase the physical cards from the store using specific methods of payment and delivery.

However, the services provided by the aforesaid web sites merely permit customers to insert personal pictures into the predetermined images provided by the web sites, and do not allow customers to freely edit the messages, characters and patterns in the template.

### SUMMARY OF THE INVENTION

Therefore, an object of the present invention is to provide a method for enabling a customer to create a customized publication through the Internet, which allows customers to edit messages, characters, and patterns in templates provided by an online store so as to create customized publications exclusive to customers.

Accordingly, a method for enabling a customer to create a customized publication through the Internet of the present invention includes the following steps of: (a) establishing in a server system a template database having a plurality of publication template files, each of the publication template files having a plurality of specific text block objects and a plurality of specific image objects available for editing by the customer; (b) in response to a connection made by the customer to the server system via a network-accessing device, enabling the server system to provide the network-accessing device with an interface that enables the network-accessing device to display contents of the template database and that allows the customer to select a desired one of the publication template files from the template database; (c) in response to selection of the desired one of the publication template files made by the customer, enabling the server system to provide the network-accessing device with a text editing function and an image editing function to allow the customer to edit the text block objects and the image objects in the selected one of the publication template files, thereby generating a customized publication electronic file for the customer; and (d) storing the customized publication electronic file thus generated in a customized publication database of the server system.

Another object of the present invention is to provide a server system for enabling a customer to create a customized publication through the Internet, which allows customers to edit messages, characters, and patterns in templates provided by an online store so as to create customized publications exclusive to customers.

Accordingly, a server system for enabling a customer to create a customized publication through the Internet of the present invention includes a template database, a text editor, an image editor, a user interface, and a customized publication database. The template database includes a plurality of publication template files. Each of the publication template files has a plurality of specific text block objects and a plurality of specific image objects available for editing by the customer. The text editor allows the customer to edit the text block objects in one of the publication template files selected by the customer. The image editor allows the customer to edit the image objects in said one of the publication template files selected by the customer. The user interface allows the customer to select said one of the publication template files from the template database and to control editing operations of the text editor and the image editor. The customized publication database stores a customized publication electronic file for the customer, which was generated as a result of editing of the text block objects and the image objects in said one of the publication template files selected by the customer.

### BRIEF DESCRIPTION OF THE DRAWINGS

Other features and advantages of the present invention will become apparent in the following detailed description of the preferred embodiment with reference to the accompanying drawings, of which:

FIG. 1 is a functional block diagram to illustrate a preferred embodiment of a server system for enabling a customer to create a customized publication through the Internet according to the present invention;

FIG. 2 is a flowchart to illustrate a preferred embodiment of a method for enabling a customer to create a customized publication through the Internet according to the present invention;

FIG. 3 is a schematic diagram of an operational screen to illustrate a user interface of the server system, in which a publication template file selected by a customer is displayed in a customized publication editing region;

FIG. 4 is a diagram similar to FIG. 3, showing that a text block object in the publication template file has been edited by the customer; and

FIG. 5 is a diagram similar to FIG. 4, showing that the pages displayed in the customized publication editing region have been changed as a result of operation of a page flip button unit by the customer.

### DETAILED DESCRIPTION OF THE PREFERRED EMBODIMENT

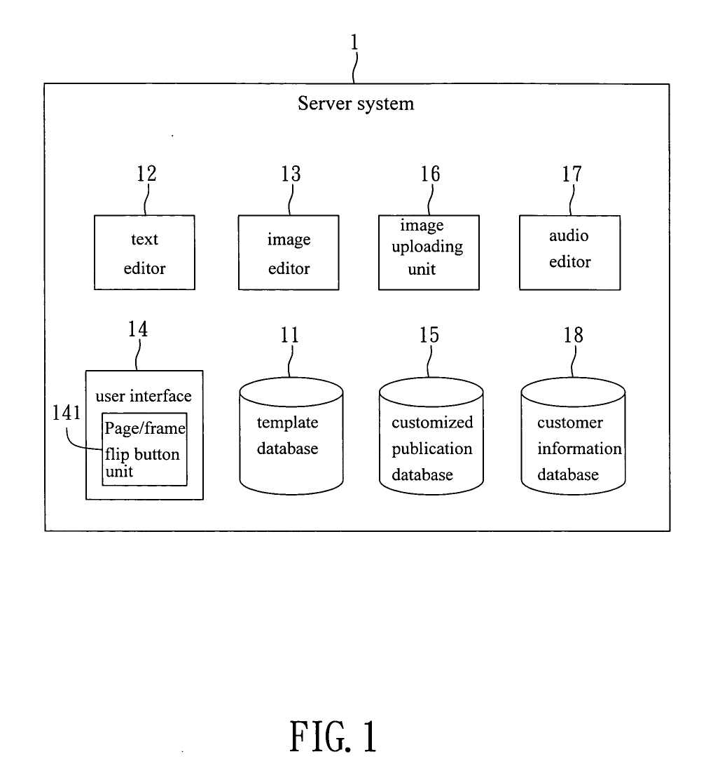

Referring to FIG. 1, the preferred embodiment of a server system 1 for enabling a customer to create a customized publication through the Internet is constructed by a store, and provides customers with publication customization services in the form of a web site. A customer can connect to the server system 1 via a network-accessing device (such as a personal computer, not shown), and utilize the server system 1 to create an electronic file of a customized publication. In this preferred embodiment, the customized publication may be, e.g., a book having a plurality of pages, a DVD containing an animated video, or a CD containing sound bites. That is, the customer can utilize the network-accessing device at any place that permits network accessing to make a connection to the server system 1 of the store through the Internet, and to employ the functions provided by the components of the server system 1 to create an electronic file of a personally exclusive customized publication for storage in the server system 1. Then, the customer can choose to have the store transform the electronic file of the customized publication into a book, a DVD, or a CD, and can also purchase the electronic file from the store so that the customer may handle subsequent publication procedures of the electronic file on his/her own by, for instance, merely printing out the electronic file using a printer at home and binding the printout into a book.

As shown in FIG. 1, the server system 1 includes a template database 11, a text editor 12, an image editor 13, a user interface 14, a customized publication database 15, an image uploading unit 16, an audio editor 17, and a customer information database 18.

The template database 11 has a plurality of publication template files with varying contents stored therein. For instance, if the target clientele of the web site mainly includes parents and children, subjects of the publication template files can be “Good Habits,” “Good Morality,” “New Siblings,” “Learning the Alphabet and 123,” “Fun Series,” “Imagination,” etc. In addition, each of the different publication template files with varying subjects has a plurality of specific text block objects and a plurality of specific image objects available for editing by the customer.

The main feature of the present invention resides in that, after enabling the customer to select a desired set of publication template files, the customer is allowed to edit the text block objects and the image objects in the selected set of publication template files using the text editing function provided by the text editor 12, the image editing function provided by the image editor 13, and/or the sound editing function.

The user interface 14 allows the customer to select one of the publication template files from the template database 11 and to control editing operations of the text editor 12 and the image editor 13. In addition, the user interface 14 has a page/frame flip button unit 141. In the case that the customized publication is a book having a plurality of pages, the page/frame flipping function provided by the page/frame flip button unit 141 allows the customer to use a mouse or a keyboard of the network-accessing device to browse through all the pages of the selected publication template file on a display of the network-accessing device. In case the publication is an animated movie, the customer can navigate to the next editable frame to edit that frame and customize it.

The customized publication database 15 stores the personally exclusive customized publication electronic file for the customer, which was generated as a result of editing of the text block objects and the image objects in the publication template file selected by the customer.

The image uploading unit 16 allows the customer to use the network-accessing device to upload a personal picture to the server system 1 such that the personal picture can be used by the image editor 13 to replace one of the image objects or insert an image object in the publication template file selected by the customer. For example, parents can upload pictures of the family to the server system 1 to replace the images of the original characters or add or delete a new image object in the selected publication template file. Thus, when their child sees a physical book having pictures of his/her family printed thereon, he/she will have a higher interest in reading the book.

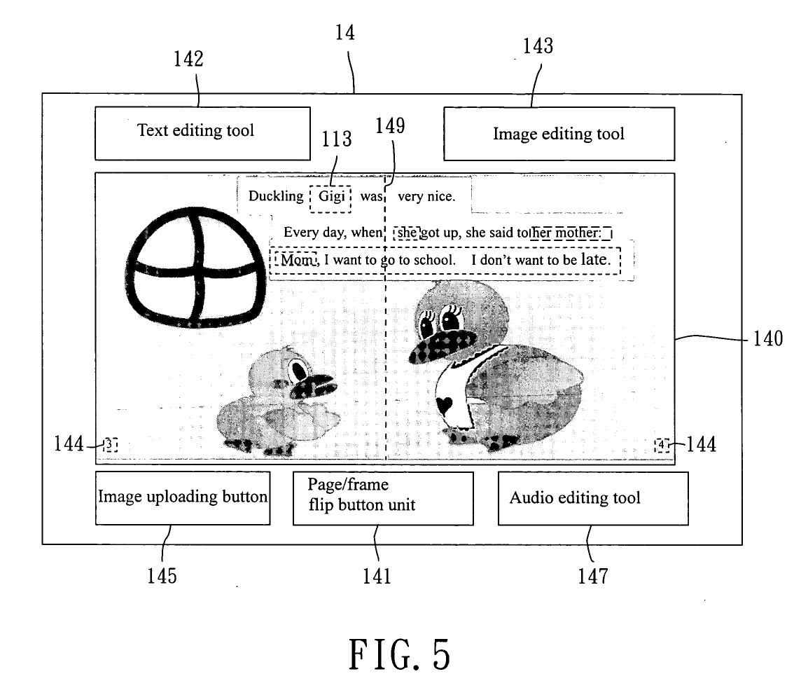

When the customized publication is a DVD or CD, the audio editor 17 allows the customer to insert various audio blocks, which may be uploaded by the customer to the server system 1 using the network-accessing device or selected by the customer from the server system 1 via the network-accessing device in addition to the image and text editing functions, into the publication template file selected by the customer such that the audio blocks form a part of the personally exclusive customized publication electronic file of the customer. The audio blocks may be inserted into the customized publication electronic file in the form of, e.g., voice messages or background music corresponding to a text message 114 (see FIG. 5).

The customer information database 18 stores personal information of the customer. The personal information includes at least one of login account number, password, payment method, method of delivery, address, feedback notes, and preferences.

Referring to FIGS. 1 to 5, the preferred embodiment of a method for enabling a customer to create a customized publication through the Internet according to the present invention includes the following steps.

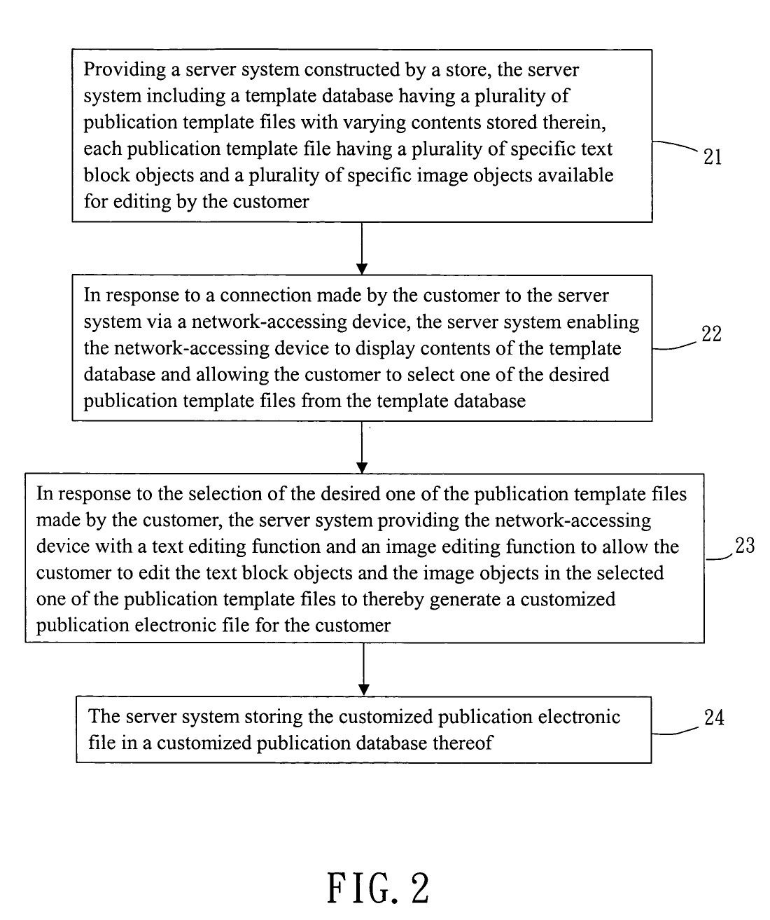

As shown in step 21 of FIG. 2, first, there is provided the server system 1 constructed by the store and as shown in FIG. 1. A template database 11 having a plurality of publication template files is established in the server system 1. Each of the publication template files has a plurality of specific text block objects and a plurality of specific image objects available for editing by the customer.

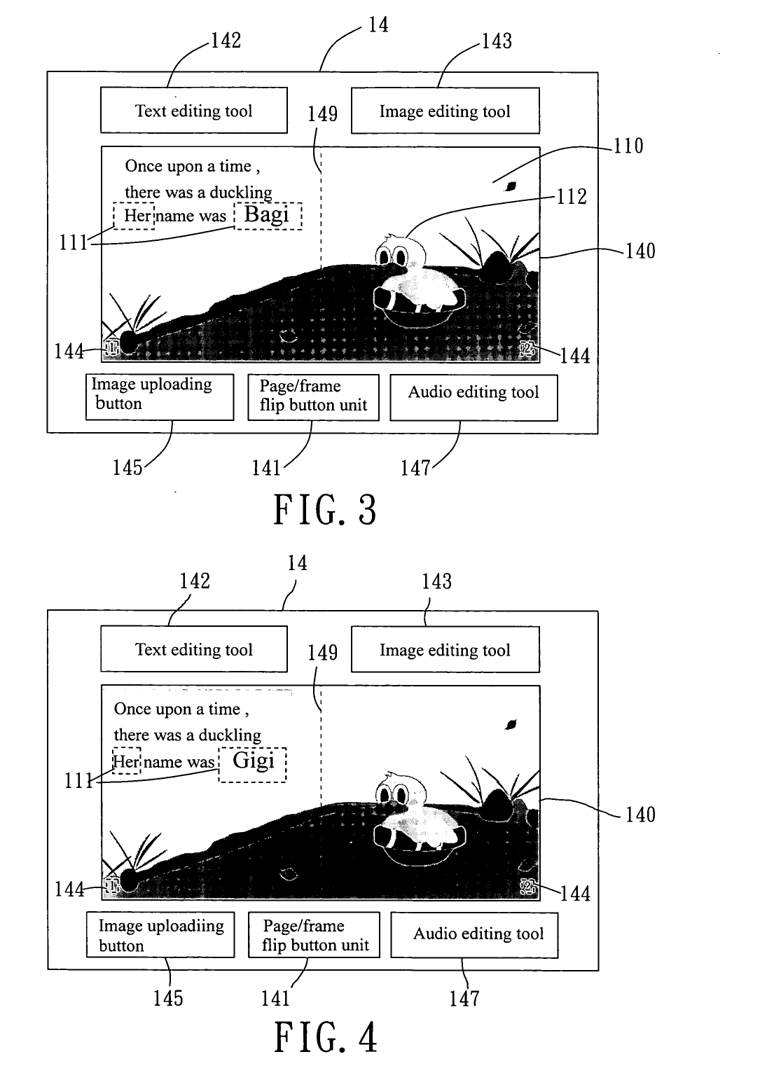

Then, as shown in step 22, in response to a connection made by the customer to the server system 1 via a network-accessing device, the server system 1 provides the network-accessing device of the customer with a user interface 14 that enables the network-accessing device to display contents of the template database 11 and that allows the customer to select a desired one of the publication template files from the template database 11. That is, the customer can browse the contents of various publication template files on the user interface 14, and select a desired one of the publication template files thereafter. For instance, when step 22 is completed, the display of the network-accessing device of the customer can show the user interface 14 as illustrated in FIG. 3, in which a customized publication editing region 140 displays the publication template file 110 selected by the customer.

It is noted that, in this embodiment, any customer entering the web site can browse various items of basic information provided by the web site, such as the various publication template files mentioned above, and need not log in as a member. However, when the customer wants to create a personally exclusive customized publication based on any of the publication template files, he/she must log in as a member. The customer can obtain membership by entering personal information, such as name, ID number, etc., in the web site, and by setting a login account and password. After obtaining membership, the customer can enter the previously set login account number and password during subsequent visits to the web site so as to log in to the web site as a member and to obtain the right to generate customized publication electronic files based on the publication template files. Since techniques relating to obtaining membership and logging in to the web site as a member belong to the prior art and are not crucial features of the present invention, a detailed description thereof is dispensed herewith for the sake of brevity.

In step 23, in response to selection of the desired one of the publication template files made by the customer, the server system 1 provides the network-accessing device with a text editing function and an image editing function to allow the customer to edit the text block objects and the image objects in the selected one of the publication template files, thereby generating a customized publication electronic file for the customer. Referring to FIG. 3, the selected publication template file 110 has a text block object 111 and an image object 112 available for editing by the customer. The customer can use the text editing function and the image editing function provided by the server system 1 to edit the text block object 111 and the image object 112 in the selected publication template file 110. Specifically, the customer can first select the text block object 111, and then click specific buttons on a text editing tool 142 to command the text editor 12 of the server system 1 to execute a specific editing function with respect to the text block object 111, e.g., changing the content, font, size, color, etc., of the text. Supposing the customer wishes to customize the character “Bagi” to “Gigi,” the customer can utilize the text editing tool 142 to change the content of the text in the text block object 111 from “Bagi” to “Gigi,” as shown in FIG. 4. In the same manner, the customer can select the image object 112, and then click specific buttons on an image editing tool 143 to command the image editor 13 of the server system 1 to execute a specific editing function with respect to the image object 112, e.g., changing the geometrical shape and color of the image. Customization can be done for anyone of interest to the customer. This implies that any edits can be made to personalize for anyone of interest to a customer.

In addition, the server system 1 also enables the customer to insert audio blocks into the selected one of the publication template files. Specifically, when the customer wants to have the customized publication created thereby to be in the form of a DVD or CD, he/she can click a specific button on an audio editing tool 147 to command the audio editor 17 of the server system 1 to insert audio blocks, which may be uploaded by the customer to the server system 1 using the network-accessing device or selected by the customer from the server system using the network-accessing device, into the publication template file 110 such that the audio blocks form a part of the customized publication electronic file exclusive to the customer.

Furthermore, the server system 1 also enables the customer to upload a personal picture thereto using the network-accessing device such that the personal picture can be used to replace one of the image objects in the selected one of the publication template files. Specifically, when the customer wants to upload his/her own picture to the server system 1, he/she can click an image uploading button 145 on the user interface 14 to execute an image uploading function of the image uploading unit 16 of the server system 1 so as to replace the image object 112 in the selected publication template file 110 with his/her own picture. For example, a parent can utilize the image uploading button 145 to upload a picture of his/her child to the server system 1 to replace the original image object 112. Thus, when the child sees a physical book or DVD with his/her own picture, he/she certainly will have a higher interest in reading the book or watching the DVD.

Since the customized publication depicted in FIGS. 3 to 5 is exemplified as a book, there is a longitudinal page break line 149 right in the middle of the customized publication editing region 140. This indicates that what is illustrated in the customized publication editing region 140 is two adjacent pages of the book. Therefore, from the page numbers 144 at the lower left corner and the lower right corner of the customized publication editing region 140 depicted in FIGS. 3 and 4, it can be seen that the pages to the left and right sides of the longitudinal page break line 149 are page 1 and page 2 of the book, respectively. When the customer wants to browse the other pages of the publication template file 110, he/she can click a button having a specific function (e.g., go to the next page, the previous page, the first page or the last page) in the page/frame flip button unit 141 to turn the pages displayed in the customized publication editing region 140 to other pages. For instance, the pages displayed in the customized publication editing region 140 are changed from page 1 and page 2 as shown in FIGS. 3 and 4 to page 3 and page 4 as shown in FIG. 5 under the control of the customer. It is noted that since the text content of the text block object 111 in FIG. 4 has been changed from “Bagi” to “Gigi,” occurrences of the character name “Bagi” throughout the publication template file 110 being edited by the customer will be automatically changed to “Gigi,” like the text 113 in FIG. 5. However, if the customer chooses to name the same character differently on a different page, for any reason he/she may choose, he/she can do so. One example is that the depicted character has a twin.

In addition, by employing the present invention, the customer not only can arbitrarily edit the text block object 111 and the image object 112 in the selected publication template file 110, he/she can also modify all the text messages 114 appearing in the selected publication template file 110 according to requirements. That is, the various publication template files 110 and the editing tools provided by the server system 1 of the present invention can indeed allow the customer to edit the messages, characters, and patterns in the publication template files online so as to create personally exclusive customized publication electronic files.

Then, as shown in step 24, the server system 1 stores the customized publication electronic file created by the customer in the customized publication database 15 of the server system 1. Thus, the customer can use one of the two methods described below to purchase the customized publication from the store.

The first method is that the customer can specify relevant buying information, such as payment method and method of delivery, in an order web page (not shown) of the user interface 14, and pay the required amount to the store in the specified manner. Afterwards, the customer can receive the personally exclusive customized publication in physical form, i.e., a book, a DVD or a CD, through the specified manner of delivery.

The second method is that the customer can make payment online to purchase the electronic file from the store so as to obtain the right to transfer the electronic file from the customized publication database 15 of the server system 1 to a storage medium (e.g., a hard disk drive, a floppy disk, or a mobile disk) of the network-accessing device of the customer. The customer can then take care of the subsequent publication procedures on his/her own, e.g., by merely using a printer at home to print out the electronic file and binding the printout into a book.

In sum, the method and server system 1 for enabling a customer to create a customized publication through the Internet according to the present invention allow the customer to edit various messages, characters and patterns in the publication template file 110 online by operating the tools, such as the text editor 12 and the image editor 13, and/or sound provided by the server system 1 online, so as to create a personally exclusive customized publication.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for enabling a customer to create a customized publication through the Internet, comprising the steps of:
(a) establishing in a server system a template database having a plurality of publication template files, each of the publication template files having a plurality of specific text block objects and a plurality of specific image objects available for editing by the customer;
(b) in response to a connection made by the customer to the server system via a network-accessing device, enabling the server system to provide the network-accessing device with an interface that enables the network-accessing device to display contents of the template database and that allows the customer to select a desired one of the publication template files from the template database;
(c) in response to selection of the desired one of the publication template files made by the customer, enabling the server system to provide the network-accessing device with a text editing function and an image editing function to allow the customer to edit the text block objects and the image objects in the selected one of the publication template files, thereby generating a customized publication electronic file for the customer; and
(d) storing the customized publication electronic file thus generated in a customized publication database of the server system.

2. The method according to claim 1, wherein, in step (c), the server system enables the customer to upload a personal picture thereto using the network-accessing device such that the personal picture can be used to replace one of the image objects in the selected one of the publication template files.

3. The method according to claim 1, wherein, in step (c), the server system enables the customer to insert audio blocks into the selected one of the publication template files such that the audio blocks form a part of the customized publication electronic file.

4. The method according to claim 3, wherein the audio blocks are uploaded by the customer to the server system using the network-accessing device.

5. The method according to claim 3, wherein the server system is configured to permit selection of the audio blocks by the customer using the network-accessing device.

6. The method according to claim 1, wherein the customized publication is a book having a plurality of pages, and, in step (c), the server system further provides a page flip function to enable the customer to browse through pages of the selected one of the publication template files using the network-accessing device.

7. A server system for enabling a customer to create a customized publication through the Internet, comprising:
a template database including a plurality of publication template files, each of the publication template files having a plurality of specific text block objects and a plurality of specific image objects available for editing by the customer;
a text editor for allowing the customer to edit the text block objects in one of the publication template files selected by the customer;
an image editor for allowing the customer to edit the image objects in said one of the publication template files selected by the customer;
a user interface for allowing the customer to select said one of the publication template files from said template database and to control editing operations of said text editor and said image editor; and
a customized publication database for storing a customized publication electronic file for the customer, which was generated as a result of editing of the text block objects and the image objects in said one of the publication template files selected by the customer.

8. The server system according to claim 7, further comprising an image uploading unit for allowing the customer to upload a personal picture to said server system such that the personal picture can be used by said image editor to replace one of the image objects in said one of the publication template files selected by the customer.

9. The server system according to claim 7, further comprising an audio editor for allowing the customer to insert audio blocks into said one of the publication template files selected by the customer such that the audio blocks form a part of the customized publication electronic file.

10. The server system according to claim 7, wherein the customized publication is a book having a plurality of pages, said user interface including a page flip button unit for enabling the customer to browse through pages of said one of publication template files selected by the customer.

11. The server system according to claim 7, further comprising a customer information database for storing personal information of the customer, the personal information including at least one of login account number, password, payment method, and method of delivery.
